(19) United States
(12) Patent Application Publication
(10) Pub. No.: US 2013/0175212 A1
(43) Pub. Date: Jul. 11, 2013

(54) LOWER ADHESION BAG-TYPE FILTRATION SYSTEMS

(71) Applicant: Hideaki Baba, Kanagawa (JP)

(72) Inventor: Hideaki Baba, Kanagawa (JP)

(73) Assignee: 3M INNOVATIVE PROPERTIES COMPANY, ST. PAUL, MN (US)

(21) Appl. No.: 13/814,791

(22) PCT Filed: Aug. 10, 2011
(86) PCT No.: PCT/US11/47231

§ 371 Date: Feb. 7, 2013

Related U.S. Application Data
(60) Provisional application No. 61/375,553, filed on Aug. 20, 2010.

(51) Int. Cl. B01D 29/11

(52) U.S. Cl. CPC B01D 29/11
USPC 210/416.1; 210/486

(57) ABSTRACT

A filter cartridge for installation within a compatible pressure vessel is provided. The filter cartridge comprises a filter head comprising a fluid inlet and a fluid outlet, a filter media attached to the filter head, the filter media being in fluid communication with the fluid inlet and the fluid outlet. The filter cartridge further comprises a polymeric film attached to the filter head and forming a fluid-tight casing around the filter media, the polymeric film comprising an inner film wall facing the filter media and an outer film wall facing the pressure vessel. One or more depressions in the outer film wall create one or more fluid passages between the polymeric film and the pressure vessel when the filter cartridge is installed in the pressure vessel.

### BACKGROUND

In certain fluid filtration applications, filtration systems include a fixed or durable pressure vessel along with a disposable filter cartridge that is removable from the pressure vessel. Often, the disposable filter cartridge includes filter media enclosed within an impermeable bag. In such systems, the impermeable bag typically prevents working fluid from escaping from the filter cartridge and wetting the pressure vessel, but is insufficient on its own to withstand the operating pressure of the filtration system. Therefore, the impermeable bag is designed to bear upon the inner walls of the fixed pressure vessel during operation. As a result, the filtration system may safely operate at typical operating pressure while the impermeable bag contains working fluid within the disposable filter cartridge.

However, in such filtration systems, a quantity of working fluid typically remains within the disposable filter cartridge after the filtration operation is complete. Even after the filtration system is depressurized, this residual working fluid continues to bear, under the influence of gravity, against the inner wall of the pressure vessel. As a user attempts to lift the disposable filter cartridge from the pressure vessel, residual working fluid that has collected toward the bottom of the impermeable bag causes the bag to expand against the inner pressure vessel walls. This interaction between the impermeable bag and the walls of the pressure vessel can create a friction or adhesion, making it difficult to pull the disposable filter cartridge from the pressure vessel. Moreover, the expanded bag can create a virtual seal against the pressure vessel, thereby creating a vacuum in the portion of the pressure vessel below the expanded bag. This vacuum can create additional force for the user to work against as he or she attempts to pull the disposable filter cartridge from the pressure vessel.

One approach to addressing the above problems has been to form one or more holes in the bottom of the pressure vessel to allow air to enter from the bottom up as the disposable filter cartridge is lifted, thereby preventing formation of a vacuum. However, such designs create potential pathways for unwanted leakage of working fluid out of the pressure vessel should the impermeable bag rupture or otherwise fail.

There is a need for a bag-type disposable filter cartridge that can be more easily removed from a pressure vessel. There is also a need for a bag-type disposable filter cartridge that can be more easily removed from a pressure vessel while allowing for a fluid-tight pressure vessel in the event the bag fails. There is also a need for a pressure vessel for bag-type filtration systems that can allow for easier removal of typical bag-type disposable filter cartridges while allowing for a fluid-tight pressure vessel in the event the bag fails.

### SUMMARY OF THE INVENTION

The present disclosure relates to a disposable bag-type filter cartridge that is more easily removed from a pressure vessel. The present disclosure also relates to a disposable bag-type filter cartridge that is more easily removed from a pressure vessel while allowing for a fluid-tight pressure vessel in the event the bag fails. The present disclosure further relates to a pressure vessel that allows for easier removal of typical bag-type filter cartridges while allowing for a fluid-tight pressure vessel in the event the bag fails. Such systems can decrease the effort necessary to remove a disposable bag-type filter from a pressure vessel after a filtration operation.

In one embodiment, the present disclosure includes a filter cartridge for installation within a compatible pressure vessel, the filter cartridge comprising a filter head comprising a fluid inlet and a fluid outlet. A filter media is attached to the filter head, the filter media being in fluid communication with the fluid inlet and the fluid outlet. A polymeric film is attached to the filter head forming a fluid-tight casing around the filter media. The polymeric film comprises an inner film wall facing the filter media and an outer film wall facing the pressure vessel. One or more depressions in the outer film wall create one or more fluid passages between the polymeric film and the pressure vessel when the filter cartridge is installed in the pressure vessel.

In one embodiment, the depressions are of sufficient size such that air at standard temperature and pressure is allowed to travel through the fluid passages when the filter cartridge is removed from the pressure vessel.

In some embodiments, the distance between the inner film wall and the outer film wall defines a total film thickness, wherein at least some of the depressions extend inwardly from the outer film wall to a depression depth in a range from about 10 percent to about 50 percent of the total film thickness.

In one embodiment, the depressions extend inwardly from the outer film wall to a depression depth in a range from about 10 percent to about 50 percent of the total film thickness.

In some embodiments, the total film thickness is in a range from about 80 μm to about 400 μm.

In some embodiments, at least some of the depressions comprise a minimum depression width in a range from about 500 μm to about 2000 μm. In one embodiment, each of the depressions comprises a minimum depression width in a range from about 500 μm to about 2000 μm.

In some embodiments, the depressions comprise two or more parallel channels. In one embodiment, the parallel channels are adjacent and repeat every 500 μm to 2000 μm. In one embodiment, the parallel channels are aligned with a longitudinal axis of the filter cartridge. In another embodiment, the parallel channels are disposed at an acute angle relative to a longitudinal axis of the filter cartridge.

In one embodiment, the depressions comprise two or more non-parallel channels.

In some embodiments, the depressions comprise a plurality of dimples.

In some embodiments, at least some of the depressions surround a plurality of discrete protrusions. In one embodiment, the discrete protrusions are disposed in a repeating pattern on the outer film wall. In some embodiments, at least some of the discrete protrusions repeat every 500 μm to 2000 μm. In one embodiment, the discrete protrusions are uniform and repeat every 500 μm to 2000 μm.

In some embodiments, the polymeric film comprises a conductive polymer.

In another embodiment, the present disclosure includes a pressure vessel comprising a pressure vessel inner wall, the pressure vessel being adapted to hold a compatible filter cartridge, the filter cartridge comprising a polymeric film attached to a filter head and forming a fluid-tight casing around a filter media, the polymeric film comprising an inner film wall facing the filter media and an outer film wall facing the pressure vessel inner wall. In such embodiments, the pressure vessel inner wall comprises one or more depressions that create one or more fluid passages between the polymeric film and the pressure vessel when the filter cartridge is installed in the pressure vessel. In such embodiments, substantially all of the variations of embodiments of depressions described in conjunction with an outer film wall may be alternatively employed on the inner pressure vessel wall.

In yet another embodiment, the present disclosure includes a filtration system comprising a pressure vessel comprising a pressure vessel inner wall and a filter cartridge for installation within the pressure vessel. In such embodiments, the filter cartridge comprises a filter head comprising a fluid inlet and a fluid outlet, a filter media attached to the filter head, the filter media being in fluid communication with the fluid inlet and the fluid outlet, and a polymeric film attached to the filter head and forming a fluid-tight casing around the filter media, the polymeric film comprising an inner film wall facing the filter media and an outer film wall facing the pressure vessel inner wall. In such embodiments, at least one of the outer film wall or the pressure vessel inner wall comprises one or more depressions that create one or more fluid passages between the polymeric film and the pressure vessel when the filter cartridge is installed in the pressure vessel.

In some such embodiments of the filtration system, the outer film wall comprises one or more depressions, but the pressure vessel inner wall does not comprise any depressions.

In other embodiments of the filtration system, the pressure vessel inner wall comprises one or more depressions, but the outer film wall does not comprise any depressions.

In yet other embodiments of the filtration system, both the pressure vessel inner wall and the outer film wall comprise one or more depressions.

In any above embodiments of the disclosed filtration system, substantially all of the variations of embodiments of depressions described in conjunction with an outer film wall may be alternatively employed on the inner pressure vessel wall, or on both.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1A is a top view of an exemplary filter cartridge according to the present disclosure;

FIG. 1B is a perspective view of an exemplary filter cartridge according to the present disclosure;

FIG. 2 is a cross-section view taken at X-X of FIG. 1A depicting an exemplary filter cartridge according to the present disclosure;

FIG. 3 is a cross-section view taken at Y-Y of FIG. 2 depicting an exemplary filter cartridge according to the present disclosure;

FIG. 4A is a detailed cross-section view taken at Y-Y of FIG. 2, as called out in FIG. 3, of a prior art film used in a bag-type filter cartridge;

FIGS. 4B-4F are detailed cross-section views taken at Y-Y of FIG. 2, as called out in FIG. 3, of exemplary polymeric films according to the present disclosure;

FIG. 4D′ is a detailed perspective cross-section view of the embodiment depicted in FIG. 4D;

FIG. 5 is an exploded perspective view of an exemplary filtration system according to the present disclosure;

FIG. 6 is a cross-section view of the filtration system depicted in FIG. 5 in an assembled state and partially filled with a residual working fluid;

FIG. 7 is a cross-section view taken at Z-Z of FIG. 6 of an exemplary filtration system according to the present disclosure;

FIGS. 8A-8B are detailed cross-section views taken at Z-Z of FIG. 6, as called out in FIG. 7, of exemplary polymeric films and compatible pressure vessels according to the present disclosure; and

FIG. 9 is a schematic view of a test fixture for evaluating polymeric films according to the present disclosure.

### DETAILED DESCRIPTION OF THE DRAWINGS

Filter cartridges according to the present disclosure may be considered part of a genus of filter cartridges known as “bag-type” filter cartridges. These bag-type filter cartridges typically encase a disposable filtration media inside a flexible bag for insertion into a rigid pressure vessel during operation. The bag serves to contain the working fluid within the filter cartridge 100, while the pressure vessel serves to withstand the working pressure of the filter system, thus preventing the bag from rupturing. The bag and filter cartridge 100 may be discarded after use. Such filter cartridges can be more economical than those with integral pressure vessels, since less material is disposed of when the filter cartridge 100 is spent. Bag-type filter cartridges can also result in faster system cycle times compared against those with exposed media because the bag prevents wetting of the pressure vessel, thereby eliminating the need to clean the pressure vessel between runs. Examples of bag-type filter cartridges and filtration systems, including potential materials of construction, may be found in U.S. Pat. Nos. 5,919,362 to Barnes et al., and 4,836,925 and 4,929,352 to Wolf, the disclosures of which are hereby incorporated by reference in their entirety.

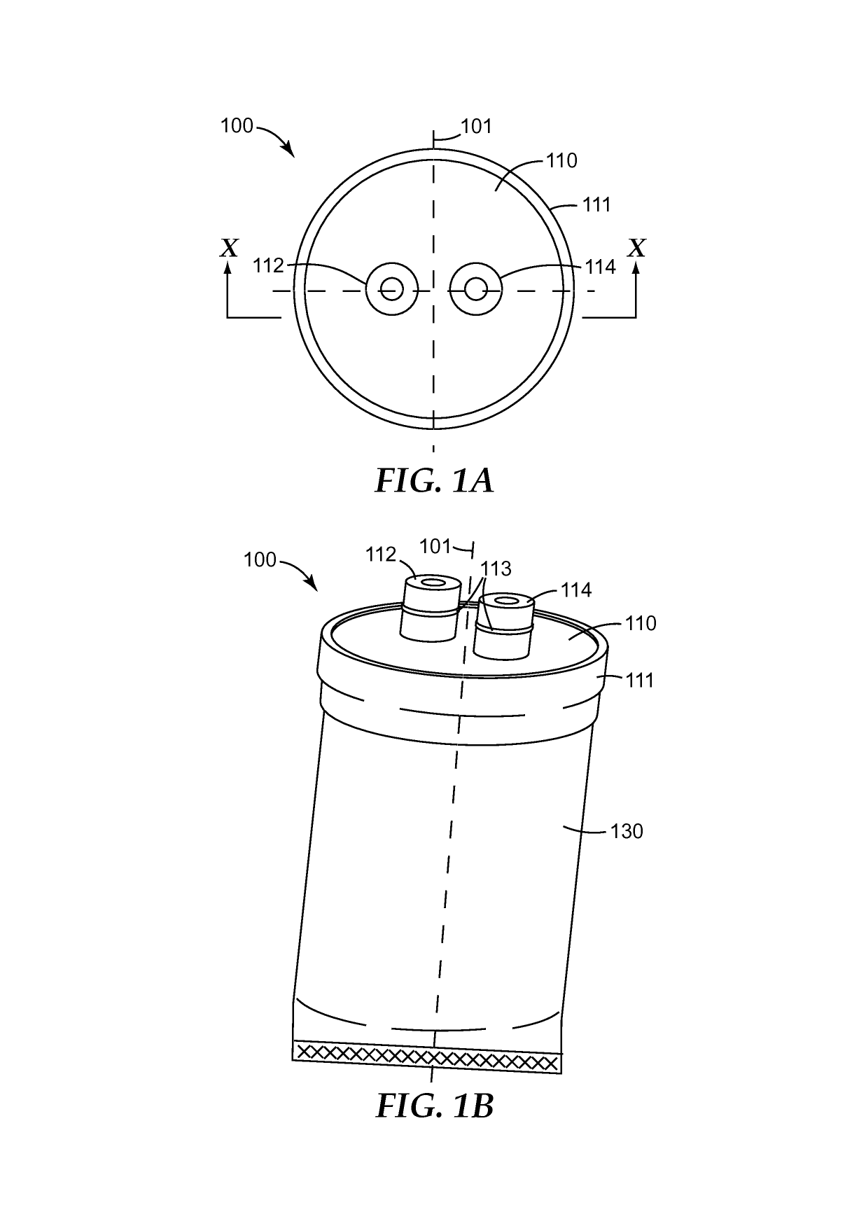

FIG. 1A is a top view of an exemplary filter cartridge 100 according to the present disclosure. As shown, filter cartridge 100 has a longitudinal axis 101. An inlet 112 and an outlet 114 are disposed on a filter head 110.

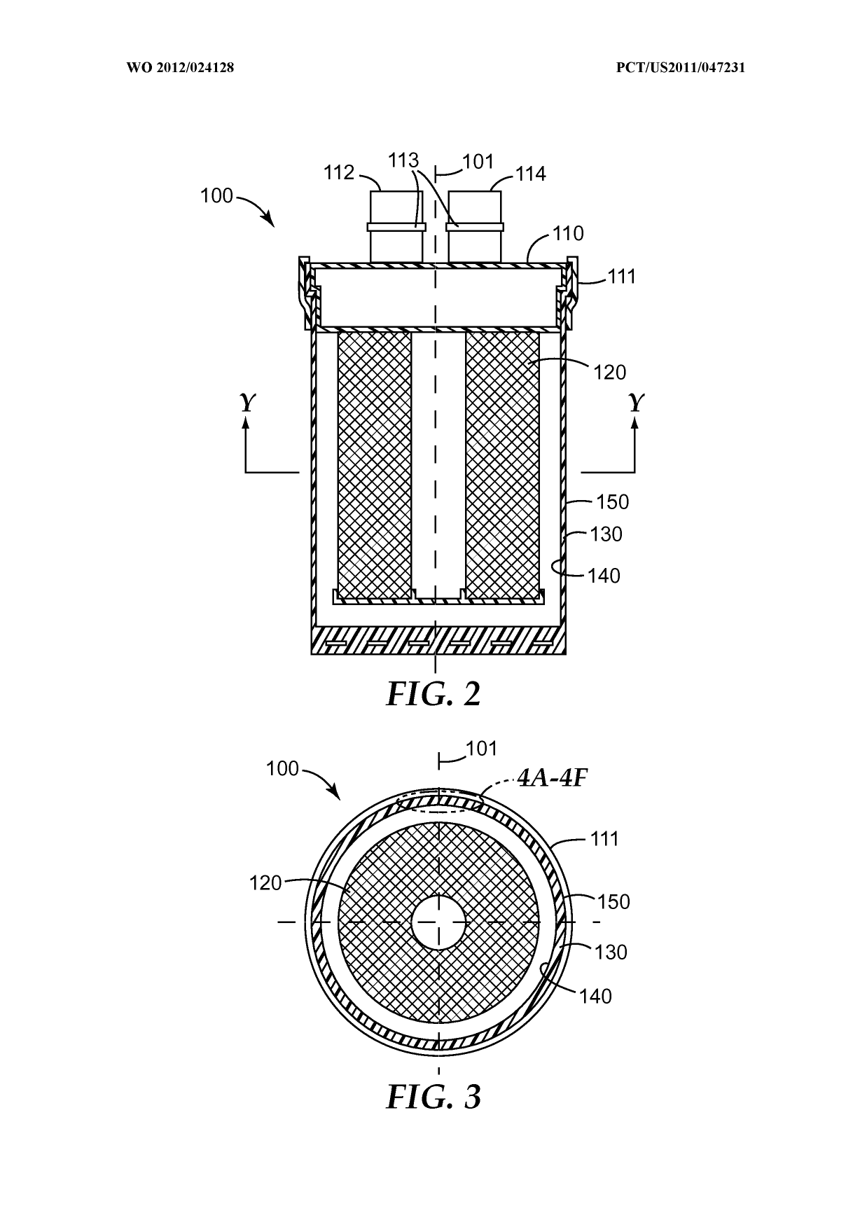

FIG. 1B is a perspective view of the filter cartridge 100 of FIG. 1A. FIGS. 2 and 3 depicted various a cross section views of the filter cartridge 100 of FIG. 1B. The filter cartridge 100 comprises a filter head 110 comprising a fluid inlet 112 and a fluid outlet 114. A filter media 120 is secured to the filter head 110 such that a fluid flowing from the fluid inlet 112 to the fluid outlet 114 can flow through the filter media 120. In the embodiment shown, both fluid inlet 112 and fluid outlet 114 comprise a sealing member 113 to allow the filter cartridge 100 to fluidly seal to a compatible filtration manifold (not shown). As shown, sealing member 113 is an o-ring, but could also be a gasket or any other fluid sealing means commonly known in the art. It is noted that the internal configuration of the filter head 110, including fluid paths corresponding to fluid inlet 112 and fluid outlet 114, is not shown. Such particular internal configuration is not important so long as the filter cartridge 100 is capable of allowing a working fluid to pass into the filter cartridge 100, through the filter media 120, and back out of the filter cartridge 100.

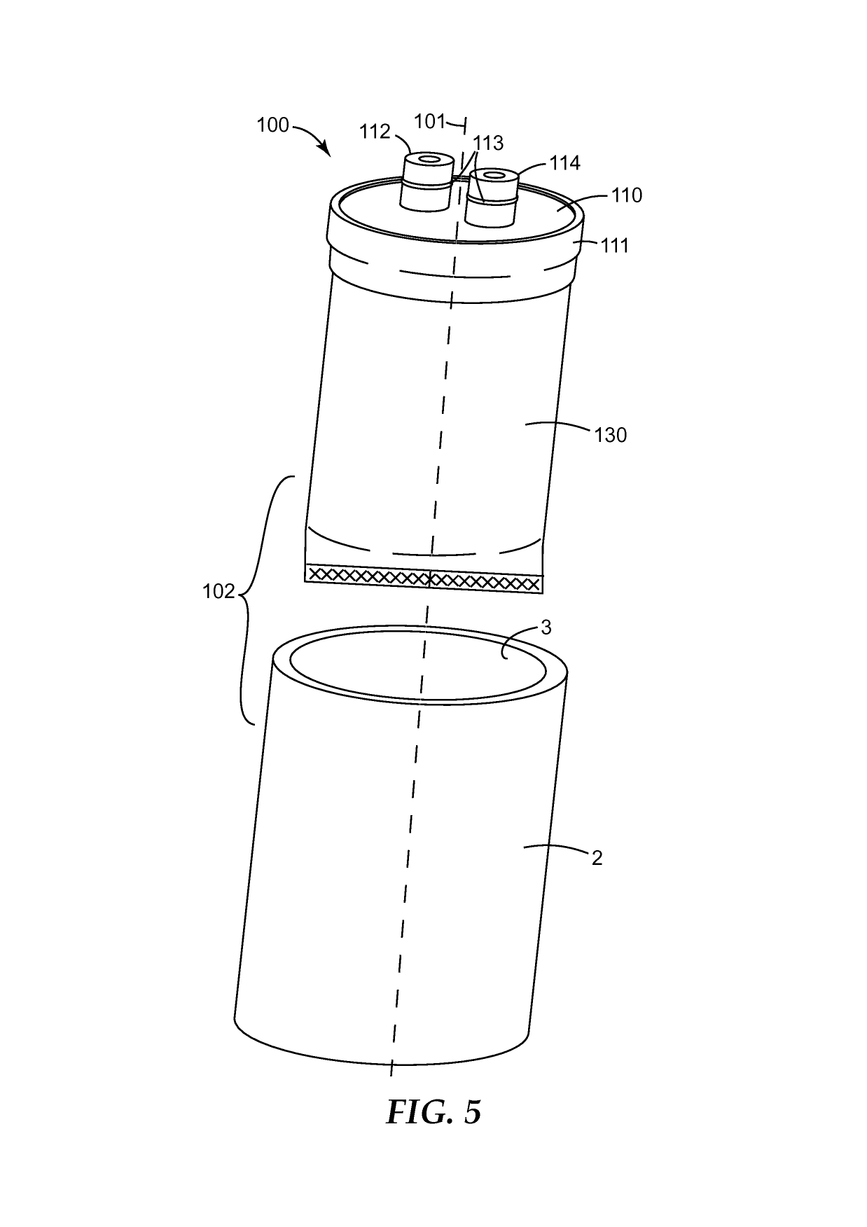

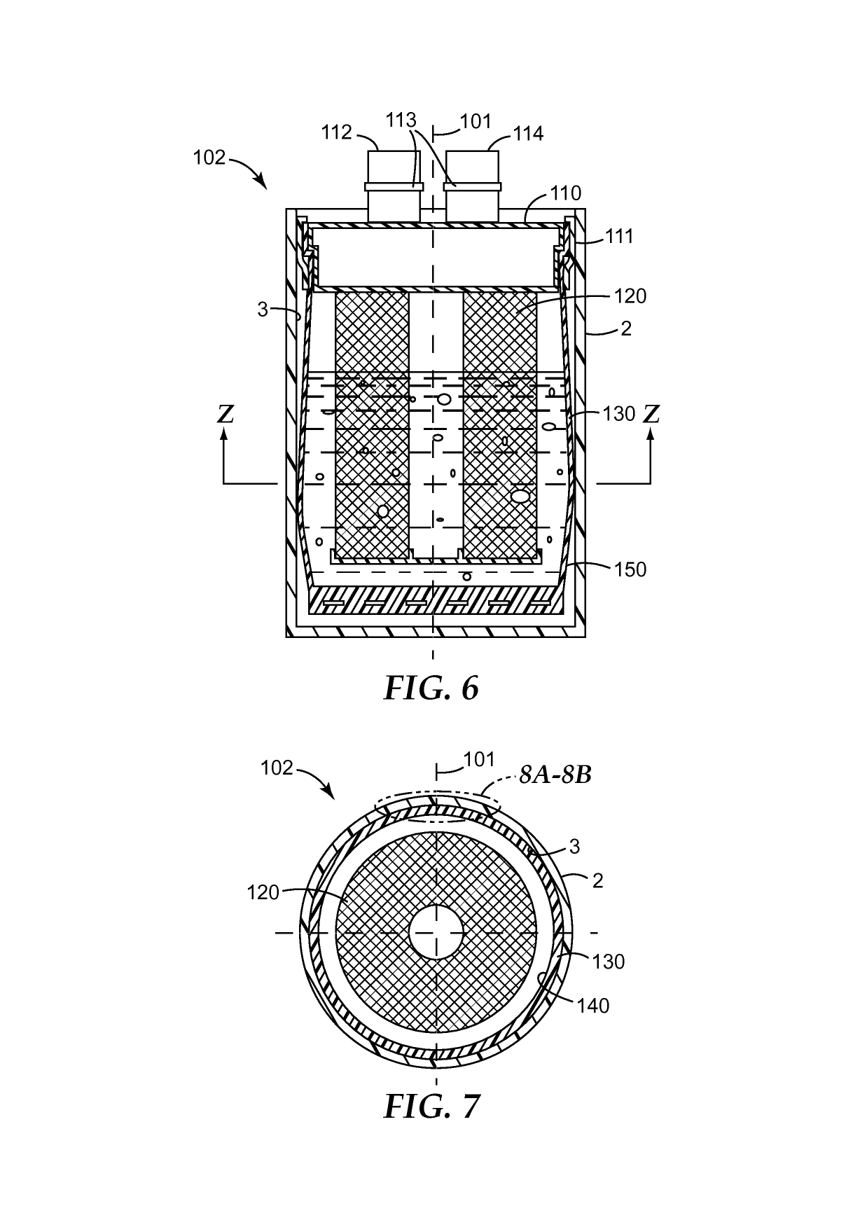

FIG. 5, discussed in more detail later, depicts an exploded filtration system 102 comprising a filter cartridge 100 as shown in FIGS. 1A and 1B along with a pressure vessel 2. An assembled, or unexploded, filtration system 102 is depicted in FIGS. 6, 7, 8A, and 8B.

The filter media 120 may be any suitable filtration media for the desired application including, for example, a carbon block, pleated filtration media, spirally-wrapped filtration media, or combinations thereof.

A polymeric film 130 is also attached to the filter head 110, encasing the filter media 120. In one embodiment, the polymeric film 130 is secured to the filter head 110 with a retainer 111. The retainer 111, if used, serves to compress the polymeric film 130 against the filter head 110 to prevent bypass of any working fluid. The retainer 111 may be akin to a common sanitary clamp, a hose clamp, a snap ring, or any other mechanical means of creating a fluid-tight seal between the polymeric film 130 and the filter head 110. It is also envisioned that adhesive or heat-bonding may be employed alone or in conjunction with a retainer 111 to provide a seal between the polymeric film 130 and the filter head 110.

It is recognized that the one or more depressions 160 in the outer film wall 150 may result in a raised texture that may be more challenging for a retainer 111 to seal against. Therefore, polymeric film 130 may be heated before assembly to make the depressions 160 more malleable and thus create a better seal. Alternatively, the portion of the polymeric film 130 that is secured to the filter head 110 may be provided free of depressions 160 to facilitate better sealing. In any event, such difficulty sealing may not pose problems in many constructions, since the depressions 160 are on the outer film wall 150, and the more critical seal must be made between the inner film wall 140 and the filter head 110.

As shown in FIG. 2, the polymeric film 130 is sealed opposite the filter head 110 to contain fluid within the filter cartridge 100. Such sealing may be done by simple application of heat, or by ultrasonic welding, adhesives, or other polymer joining methods recognized by those skilled in the art.

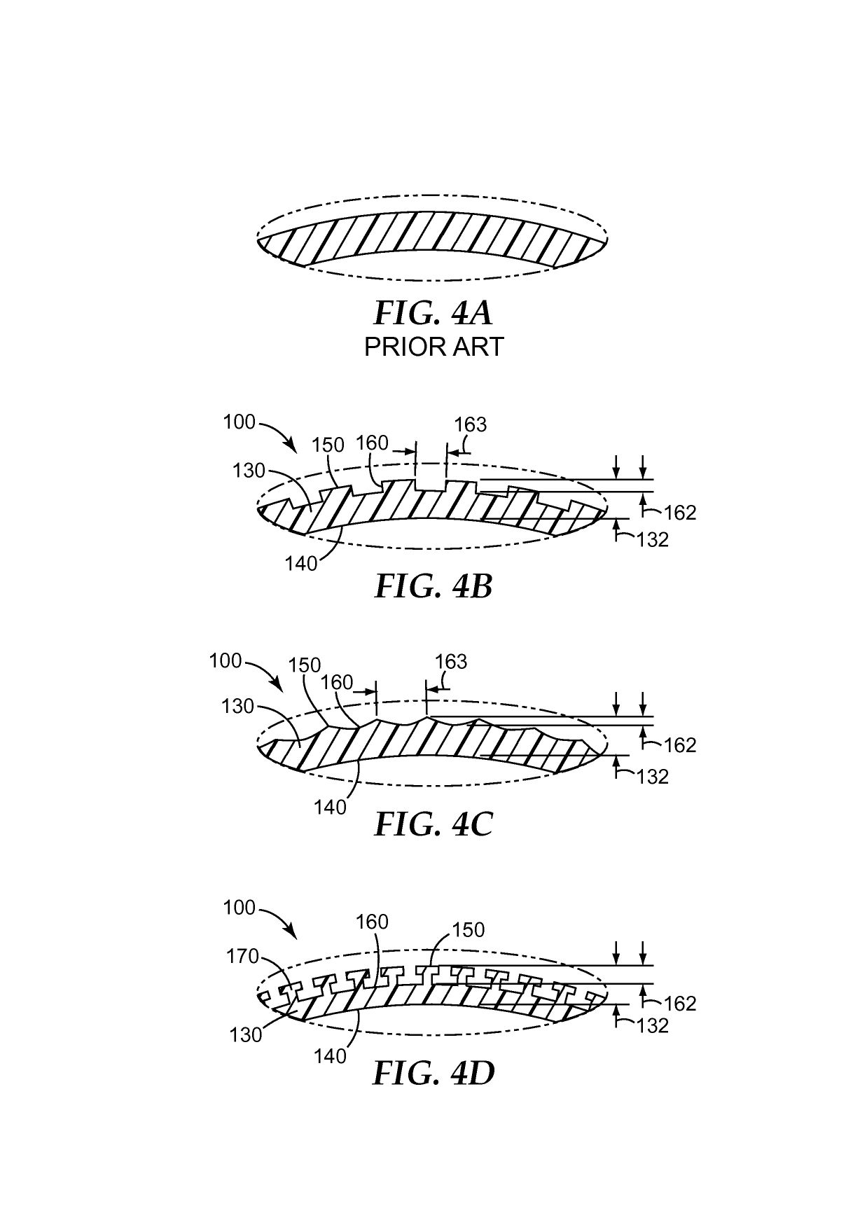

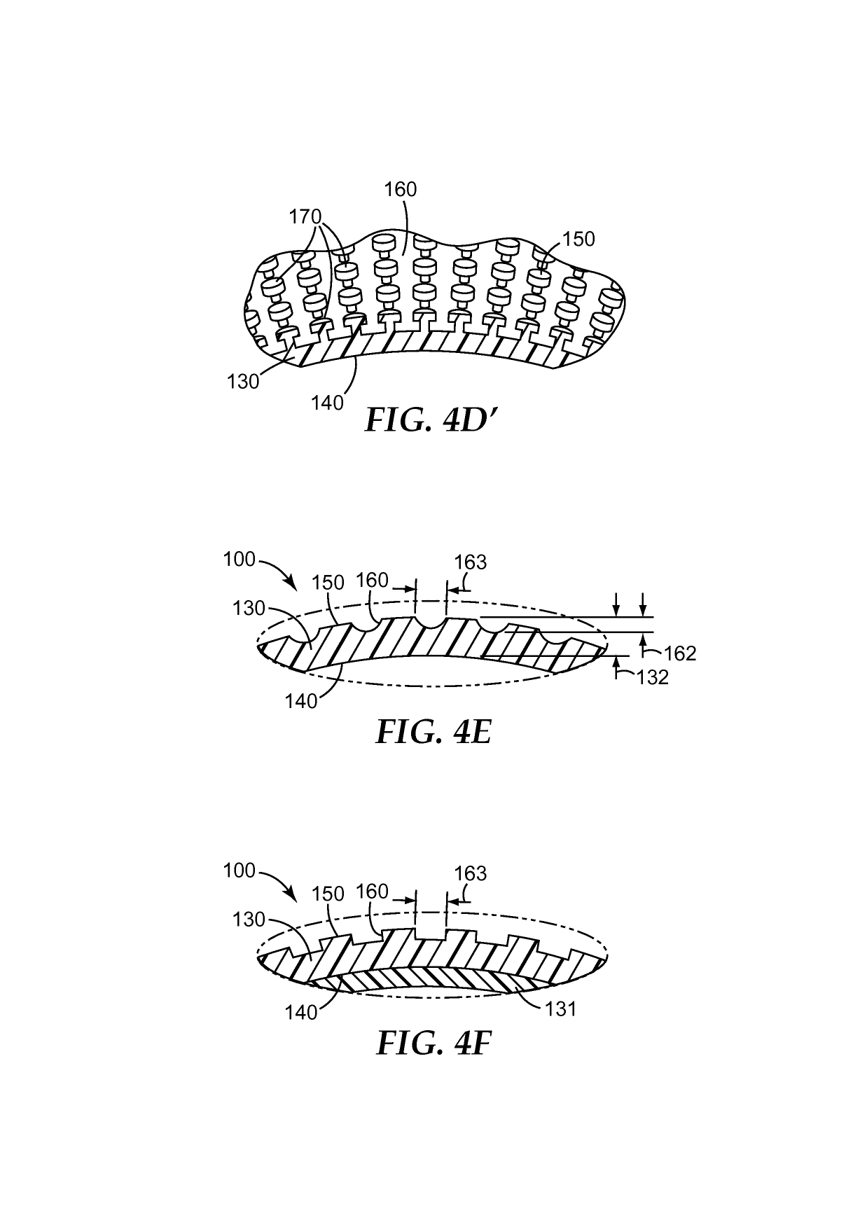

FIG. 4A is a cross-section view of a prior art polymeric film having no depressions or any provision for forming fluid passages. FIGS. 4B through 4F are detailed cross-section views of polymeric films according to the present disclosure. While not exhaustive, the embodiments shown in these detailed views depict various forms of depressions 160 on the outer film wall 150 of the polymeric film 130.

FIG. 4B depicts an exemplary polymeric film 130 according to the present disclosure. It can be seen that polymeric film 130 comprises an inner film wall 140 and an outer film wall 150. The distance between the inner film wall 140 and the outer film wall 150 defines a total film thickness 132. Here, a plurality of depressions 160 are formed in the outer film wall 150. When installed into a compatible pressure vessel 2 (not shown in FIG. 4B), these depressions 160 cooperate with the compatible pressure vessel 2 to create fluid passages 180 (not shown in FIG. 4B) that allow a fluid—typically air—to pass between the polymeric film 130 and the inner pressure vessel wall 3, thus leading to the advantages described herein. As shown in FIG. 4B, the depressions 160 are substantially rectangular in profile. The depressions 160 comprise a depression depth 162 and a depression width 163. The depressions 160 may be of any size or shape so long as they work in cooperation with the compatible pressure vessel 2 to create one or more fluid passages 180 as described herein.

Typically, the depression depth 162 is in a range from about 10 percent to about 50 percent of the total film thickness 132, including about 15, 20, 25, 30, 35, 40, or 45 percent or any range therein. Generally, if the depression depth 162 is too small, sufficient fluid passages 180 may not be created. Conversely, if the depression depth 162 is too large in comparison to the total film thickness 132, the mechanical strength of the polymeric film 130 may be compromised. It is envisioned that one or more depressions 160 may have a depth greater than 50 percent of the total film thickness 132, so long as appropriate measures were taken to ensure the mechanical strength of the polymeric film 130 was adequate. For example, provision of a backing layer 131 to back up the polymeric film 130 may sufficiently reduce or mitigate any potential risk of providing such deeper relative depression depth 162.

The depression width 163 is typically in a range from about 500 micrometers (μm) to about 2000 μm, including about 600, 700, 800, 900, 1000, 1100, 1200, 1300, 1400, 1500, 1600, 1700, 1800, or 1900 μm or any range therein. Similar to the depression depth 162 described above, if the depression width 163 is too small, sufficient fluid passages 180 may not be created. Conversely, if the depression width 163 is too large, the depression 160 may collapse outwardly onto the compatible pressure vessel 2, thus closing at least a portion of any fluid passage 180 that may otherwise have been formed.

Although the plurality of depression 160 in FIG. 4B are depicted as uniformly spaced about the outer film wall 150, it is envisioned that any spacing, be it patterned or random, may be employed so long as suitable fluid passages 180 can be formed in cooperation with a compatible pressure vessel 2.

Similarly, although the plurality of depression 160 in FIG. 4B are depicted as uniform in profile, it is envisioned that any combination of profiles, be it patterned or random, may be employed so long as suitable fluid passages 180 can be formed in cooperation with a compatible pressure vessel 2. Exemplary profiles are discussed below. It should be understood that the various depression 160 profiles expressly depicted herein are merely examples and are not intended to limit the scope of depression 160 profiles contemplated under the present disclosure.

In FIG. 4C, another embodiment of depressions 160 is depicted. In this case, the one or more depressions 160 are concave in profile. As shown, each depression 160 is immediately adjacent another depression 160 with essentially no space in between. An alternative to the embodiment of FIG. 4C is shown in FIG. 4E, wherein depressions 160 are concave in profile but are uniformly spaced apart from adjacent depressions 160. As noted above, it is envisioned that any spacing, be it patterned or random, may be employed so long as suitable fluid passages 180 can be formed in cooperation with a compatible pressure vessel 2.

Any of the depressions 160 depicted, for example, in FIGS. 4B and 4C may be disposed substantially parallel to one another and co-linear with the longitudinal axis 101 of the filter cartridge 100. In such embodiments, the depressions 160 may result in two or more parallel channels in the outer film wall 150. However, such parallel channels may alternatively or additionally be disposed at an acute angle to the longitudinal axis 101.

In the alternative, one or more of the depressions 160 may be disposed in a non-parallel fashion with respect to one another. In such embodiments, the depressions 160 may result in two or more non-parallel channels in the outer film wall 150. One or more of such non-parallel channels may be disposed either parallel to or at an acute angle to the longitudinal axis 101.

The above depression and channel configurations may be adopted and adjusted to suit a particular application or to give a desired aesthetic affect, so long as suitable fluid passages 180 are formed in cooperation with a compatible pressure vessel 2. Combinations of the above channel configurations are also envisioned.

In some embodiments, such as the one depicted in FIGS. 4D and 4D′, the depressions 160 surround a plurality of discrete protrusions 170. FIG. 4D′ is a perspective view of FIG. 4D and is provided to clarify the embodiment of FIG. 4D in three dimensions. As shown, each discrete protrusion 170 comprises a “T-shaped” profile. However, discrete protrusions 170 could comprise any profile so long as suitable fluid passages 180 could be formed in cooperation with a compatible pressure vessel 2. For example, a discrete protrusion 170 may comprise a three-dimensional shape such as a cylinder, a cone, or a pyramid. Similarly, a discrete protrusion 170 may comprise a post having a head affixed at one end, such as those depicted in FIGS. 4D and 4D′. Such post and/or optional head may be, for example, cylindrical, rectangular, or triangular in cross-section, or may comprise a combination of such cross-sections. Other, more complex geometries are also envisioned. Whatever the profile, the plurality of discrete protrusions 170 may collectively result in the outer film wall 150 having a textured surface providing suitable fluid passages 180 in cooperation with a compatible pressure vessel 2.

The depressions 160 may be of any shape or configuration, so long as the fluid passages 180 formed by the cooperation of the depressions 160 and the inner pressure vessel wall 3 allow a Fluid—typically air—to pass between the polymeric film 130 and the inner pressure vessel wall 3. The passage of fluid through the fluid passages 180 can prevent the polymeric film 130 from creating a seal against the inner pressure vessel wall 3. Prevention of a seal can prevent formation of a vacuum when the filter cartridge 100 is removed from the compatible pressure vessel 2, thus lessening the force required to remove the filter cartridge 100.

FIG. 4F shows a polymeric film 130 as depicted in FIG. 4B with the additional provision of backing layer 131 positioned against the inner film wall 140. In such embodiments, typically only the polymeric film 130 comprises depressions 160. In embodiments where multiple layers are provided, each layer may be constructed from similar or identical polymers, or may comprise differing compositions to suit the desired application. Provision of multiple layers can provide redundant leak prevention in the event one or more layers are compromised. Where certain depressions 160 in the outer film wall 150 may result in a potentially weaker film wall, a backing layer 131 can protect against leakage should the outer film wall 150 be damaged during installation or removal from the compatible pressure vessel 2.

The polymeric film 130 and/or optional backing layer 131 may comprise any suitable polymer composition. In one embodiment, the polymeric film 130 and/or optional backing layer 131 comprises polyethylene. Various potential materials and general filter cartridge 100 configurations are described in U.S. Pat. Nos. 5,919,362 to Barnes et al., and 4,836,925 and 4,929,352 to Wolf, the disclosures of which are hereby incorporated by reference in their entirety.

In one embodiment the polymeric film 130 and/or optional backing layer 131 comprises a polymer having electrically conductive or anti-static properties. Such anti-static constructions may be beneficial, for example, in industrial environments where flammable vapors may be present. By reducing or preventing an electrical charge build-up on the outer film wall 150, the risk of electrical arcing between the polymeric film 130 and the compatible pressure vessel 2 is reduced, thereby lessening the risk of accidental ignition of flammable vapors.

As discussed above, FIG. 5 depicts a filtration system 102 comprising a filter cartridge 100 and a compatible pressure vessel 2 according to the present disclosure. Filter cartridge 100 is shown disassembled from compatible pressure vessel 2 along longitudinal axis 101. As shown, compatible pressure vessel 2 is a simplified blind cylinder with one open end and an inner pressure vessel wall 3.

FIG. 6 is a cross sectional view of the filtration system 102 of FIG. 5 in an assembled state with the filter cartridge 100 inserted into compatible pressure vessel 2. As shown, polymeric film 130 is partially filled with a working fluid, as would be common after use of the filtration system 102. The residual fluid causes the polymeric film 130 to expand radially outwardly and contact the inner pressure vessel wall 3, thereby taking on a somewhat bowed shape as shown. Therefore, the polymeric film 130 will tend to be forced against the inner pressure vessel wall 3 as the filter cartridge 100 is removed from the compatible pressure vessel 2.

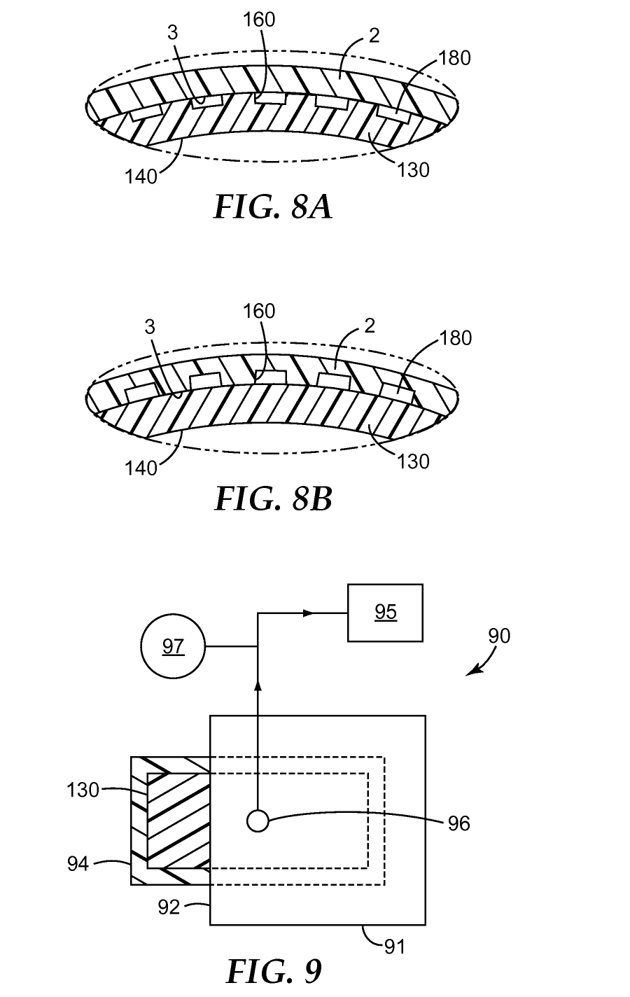

FIG. 7 is a cross-section view taken at Z-Z of FIG. 6 at the point where polymeric film 130 is forced against inner pressure vessel wall 3. This contact point is further detailed in FIG. 8A, where the interaction between the polymeric film 130 and the inner pressure vessel wall 3 can be seen. As is clearly shown in FIG. 8A, a plurality of fluid passage 180 are formed through cooperation of the polymeric film 130 and the inner pressure vessel wall 3. As earlier described, such fluid passages 180 can allow for easier extraction of the filter cartridge 100 from the compatible pressure vessel 2 due to reduced friction and the prevention of a vacuum.

While the principals discussed above relate generally to filter cartridges having polymeric films comprising depressions 160, it should also be understood that, in other embodiments, similar depressions 160 could be instead provided on an inner wall of a compatible pressure vessel 2, as shown in FIG. 8B. So long as suitable fluid passages 180 are formed by cooperation of the polymeric film 130 and the compatible pressure vessel 2, the one or more depressions 160 could be provided on either or both parts.

Effectiveness of exemplary polymeric films according to the present disclosure was evaluated using a test fixture and test method as described below.

Test Fixture

The Test Fixture 90 included a flat film polymer pouch 91 having a pocket 92 with one open end 93, a metallic plate 94 constructed to fit within the open end 93 of the pocket 92, a vacuum source 95 connected to a vacuum port 96 to pull a vacuum on the pocket 92, a pressure gauge 97 to determine the level of vacuum within the pocket 92, and a timer to evaluate the change in vacuum over time. The surface of the film used to construct the polymer pouch, including the inner walls of the pocket 92, was smooth and flat. The surface of the metallic plate 94 was also smooth and flat. The pocket 92 and the metallic plate 94 were constructed to allow a piece of a polymeric film 130 according to the present disclosure to fit within the open end 93 of the pocket 92 such that the polymeric film 130 could be compressed, or “sandwiched” between the metallic plate 94 and one wall of the pocket 92 when a vacuum was pulled on the pocket 92. One end of both the metallic plate 94 and the polymeric film 130 to be evaluated protruded from the open end 93 of the pocket 92. The pocket 92 measured about 110 mm wide by about 170 mm deep. The vacuum port 96 was positioned along the centerline of the pocket 92 and about 50 mm from the open end 93 of the pocket 92. The metallic plate 94 measured about 100 mm wide, 200 mm long, and about 0.3 mm thick. A schematic representation of the test fixture 90 is depicted in FIG. 9.

Test Method

A polymeric film 130 to be evaluated was placed into the test fixture 90 as described above. A small amount of water (in an approximate range from 2 to 5 mL) was then placed in the pocket 92 and the vacuum source 95 started. As the vacuum was being pulled on the pocket 92, any remaining air within the pocket 92 was pressed out. The water in the pocket 92 ensured that any remaining gaps within the pocket 92 were filled with water and that the walls of the pocket 92 were held together somewhat by the resulting surface tension. The vacuum was pulled until the pressure gauge 97 read 10 Torr. A 10 Torr vacuum was held for approximately 10 seconds, at which time the vacuum source 95 was turned off and the timer was started. When the pressure gauge 97 had increased to indicate atmospheric pressure (about 760 Torr), the timer was turned off, and the elapsed time recorded. A shorter elapsed time indicated a relatively faster transfer of air into the pocket 92. Thus, a shorter elapsed time indicated a more effective polymeric film for purposes of the present disclosure. The above Test Method steps were repeated 25 times for each test to confirm stability of the results.

Evaluation

To establish a control, the Test Method above was completed with no polymeric film inserted into the pocket 92, such that the smooth surfaces of the pocket 92 wall and the metallic plate 94 were in direct contact. To evaluate polymeric films 130 according to the present disclosure, such films were placed into the test fixture 90 as described above and evaluated according to the Test Method.

Two polymeric films 130, labeled as Example A and Example B in Table 1 below, were evaluated against the control. The configuration of the films used for Examples A and B comprised concave depressions 160 similar to those shown in the polymeric film 130 depicted in FIG. 4C.

TABLE 1

| | Example A | Example B |
|---|---|---|
| Film Material | Polyethylene | Polyethylene |
| Film Thickness (μm) | 210 | 210 |
| Depression Width (μm) | 800 | 1300 |
| Depression Depth (μm) | 45 | 55 |

Test Results

The results of the evaluations are summarized in Table 2 and Chart 1 below.

TABLE 2

| | Elapsed Time (seconds) | | |
|---|---|---|---|
| | | Example | Example |
| Run No. | Control | A | B |
| 1 | 52 | 33 | 36 |
| 2 | 57 | 33 | 36 |
| 3 | 60 | 34 | 36 |
| 4 | 53 | 34 | 35 |
| 5 | 56 | 35 | 35 |
| 6 | 54 | 36 | 35 |
| 7 | 54 | 34 | 35 |
| 8 | 54 | 34 | 35 |
| 9 | 54 | 34 | 35 |
| 10 | 54 | 34 | 36 |
| 11 | 54 | 31 | 31 |
| 12 | 54 | 35 | 30 |
| 13 | 55 | 32 | 32 |
| 14 | 55 | 30 | 32 |
| 15 | 55 | 31 | 34 |
| 16 | 52 | 34 | 38 |
| 17 | 52 | 37 | 34 |
| 18 | 52 | 39 | 36 |
| 19 | 52 | 35 | 35 |
| 20 | 52 | 36 | 36 |
| 21 | 53 | 31 | 35 |
| 22 | 54 | 32 | 29 |
| 23 | 50 | 35 | 30 |
| 24 | 53 | 37 | 30 |
| 25 | 52 | 31 | 30 |
| Average | 54 | 34 | 34 |

It can be seen from the data above that Examples A and B of polymeric films 130 according to the present disclosure exhibited substantially reduced elapsed times, and thus performed substantially better than the control.

Various modifications and alterations of the invention will be apparent to those skilled in the art without departing from the spirit and scope of the invention. It should be understood that the invention is not limited to illustrative embodiments set forth herein.

1. A filter cartridge for installation within a compatible pressure vessel, the filter cartridge comprising:
a filter head comprising a fluid inlet and a fluid outlet;
a filter media attached to the filter head, the filter media being in fluid communication with the fluid inlet and the fluid outlet;
a polymeric film attached to the filter head and forming a fluid-tight casing around the filter media, the polymeric film comprising an inner film wall facing the filter media and an outer film wall facing the pressure vessel; and
one or more depressions in the outer film wall that create one or more fluid passages between the polymeric film and the pressure vessel when the filter cartridge is installed in the pressure vessel.

2. The filter cartridge of claim 1 wherein the depressions are of sufficient size such that air at standard temperature and pressure is allowed to travel through the fluid passages when the filter cartridge is removed from the pressure vessel.

3. The filter cartridge of claim 1 wherein the distance between the inner film wall and the outer film wall defines a total film thickness; wherein at least some of the depressions extend inwardly from the outer film wall to a depression depth in a range from about 10 percent to about 50 percent of the total film thickness.

4. The filter cartridge of claim 3 wherein each of the depressions extend inwardly from the outer film wall to a depression depth in a range from about 10 percent to about 50 percent of the total film thickness.

5. The filter cartridge of claim 3 wherein the total film thickness is in a range from about 80 μm to about 400 μm.

6. The filter cartridge of claim 1 wherein at least some of the depressions comprise a depression width in a range from about 500 μm to about 2000 μm.

7. The filter cartridge of claim 6 wherein each of the depressions comprises a depression width in a range from about 500 μm to about 2000 μm.

8. The filter cartridge of claim 1 wherein the depressions comprise two or more parallel channels.

9. The filter cartridge of claim 8 wherein the parallel channels are adjacent and repeat every 500 μm to 2000 μm.

10. The filter cartridge of claim 8 wherein the parallel channels are aligned with a longitudinal axis of the filter cartridge.

11. The filter cartridge of claim 8 wherein the parallel channels are disposed at an acute angle relative to a longitudinal axis of the filter cartridge.

12. The filter cartridge of claim 1 wherein the depressions comprise two or more non-parallel channels.

13. The filter cartridge of claim 1 wherein the depressions comprise a plurality of dimples.

14. The filter cartridge of claim 1 wherein at least some of the depressions surround a plurality of discrete protrusions.

15. The filter cartridge of claim 14 wherein the discrete protrusions are disposed in a repeating pattern on the outer film wall.

16. The filter cartridge of claim 14 wherein at least some of the discrete protrusions repeat every 500 μm to 2000 μm.

17. The filter cartridge of claim 16 wherein the discrete protrusions are uniform and repeat every 500 μm to 2000 μm.

18. The filter cartridge of claim 1 wherein the polymeric film comprises a conductive polymer.

19. A pressure vessel comprising a pressure vessel inner wall, the pressure vessel being adapted to hold a compatible filter cartridge, the filter cartridge comprising:
a polymeric film attached to a filter head and forming a fluid-tight casing around a filter media, the polymeric film comprising an inner film wall facing the filter media and an outer film wall facing the pressure vessel inner wall;
wherein the pressure vessel inner wall comprises one or more depressions that create one or more fluid passages between the polymeric film and the pressure vessel when the filter cartridge is installed in the pressure vessel.

20. A filtration system comprising:
a pressure vessel comprising a pressure vessel inner wall; and
a filter cartridge for installation within the pressure vessel, the filter cartridge comprising:
a filter head comprising a fluid inlet and a fluid outlet;
a filter media attached to the filter head, the filter media being in fluid communication with the fluid inlet and the fluid outlet; and
a polymeric film attached to the filter head and forming a fluid-tight casing around the filter media, the polymeric film comprising an inner film wall facing the filter media and an outer film wall facing the pressure vessel inner wall;
wherein at least one of the outer film wall or the pressure vessel inner wall comprises one or more depressions that create one or more fluid passages between the polymeric film and the pressure vessel when the filter cartridge is installed in the pressure vessel.

21. The filtration system of claim 20 wherein the outer film wall comprises one or more depressions, but the pressure vessel inner wall does not comprise any depressions.

22. The filtration system of claim 20 wherein the pressure vessel inner wall comprises one or more depressions, but the outer film wall does not comprise any depressions.

23. The filtration system of claim 20 wherein both the pressure vessel inner wall and the outer film wall comprise one or more depressions.
